(19) United States
(12) Patent Application Publication
(10) Pub. No.: US 2018/0189406 A1
(43) Pub. Date: Jul. 5, 2018

(54) ARTIFICIAL INTELLIGENCE-BASED MOBILE SEARCH METHOD AND APPARATUS

(71) Applicant: BAIDU ONLINE NETWORK TECHNOLOGY (BEIJING) CO., LTD, Beijing (CN)

(72) Inventor: Hailong XIANG, Beijing (CN)

(21) Appl. No.: 15/740,915

(22) PCT Filed: Jul. 14, 2016
(86) PCT No.: PCT/CN2016/090040

§ 371 Date: Dec. 29, 2017

(30) Foreign Application Priority Data
Feb. 5, 2016 (CN) 201610082606.3

(51) Int. Cl. G06F 17/30

(52) U.S. Cl. CPC G06F 17/30867; G06F 17/30657; G06F 17/3074; G06F 17/30277

(57) ABSTRACT

Provided in the present invention are an artificial intelligence-based mobile search method and an electronic device, wherein the artificial intelligence-based mobile search method comprises: receiving a query; according to an existing resource, acquiring search results corresponding to the query; said existing resource comprising resources that a content provider provides to a search engine, said search results comprising results that meet a need and results that may inspire potential needs; displaying the search results on a search result page, and when a user clicks a search result on the search result page, displaying other pages provided by the search engine in correspondence with the clicked search result.

### CROSS REFERENCE TO RELATED APPLICATION

This application is based upon and claims a priority to Chinese Patent Application Serial No. 201610082606.3, filed with the Status Intellectual Property Office of P. R. China on Feb. 5, 2016, titled “Artificial intelligence-based mobile search method and apparatus”, filed by BAIDU ONLINE NETWORK TECHNOLOGY (BEIJING) CO., LTD., the entire contents of which are incorporated herein by reference.

### FIELD

The present disclosure relates to an internet technology field, and more particularly to a mobile search method and a mobile search apparatus based on artificial intelligence.

### BACKGROUND

Artificial intelligence (AI for short) is a new technology for studying and developing theories, methods, technologies and application systems for simulating and extending human intelligence. AI is a branch of computer science, intending to know essence of intelligence and to produce an intelligent machine acting in a way similar to that of human intelligence. Researches on the AI field refer to robots, speech recognition, image recognition, natural language processing and expert systems etc.

With a rapid popularization of smart phones, mobile internet has become a main access to information for net users nowadays. Accordingly, a mobile search may replace a PC search as a main approach of a search engine. As it may be affected by a user environment, a resource environment and other factors, there is a significant difference between the mobile search and the PC search.

In related arts, applying principles of the PC search in the mobile search may lead to the result that the mobile search has defects on aspects of controlling resource, satisfying user's requirement of precise scenes and the like.

### SUMMARY

Embodiments of the present disclosure seek to solve at least one of the problems existing in the related art to at least some extent.

Accordingly, an objective of the present disclosure is to provide a mobile search method based on artificial intelligence, aiming at breaking a normal thinking of the PC search and providing a search method more suitable for the mobile search scenario.

Another objective of the present disclosure is to provide a mobile search apparatus based on artificial intelligence.

In order to achieve the above objectives, embodiments of a first aspect of the present disclosure provide a mobile search method based on artificial intelligence. The mobile search method includes: receiving a query; acquiring search results corresponding to the query according to existing resources, in which the existing resources include resources provided to a search engine by a content provider, and the search results include requirement-satisfied results and results motivating a potential requirement; and displaying the search results on a search result page, and when a user clicks a search result on the search result page, displaying pages provided by the search engine and in correspondence with the search result clicked.

With the mobile search method based on artificial intelligence according to embodiments of the first aspect of the present disclosure, by performing the above processing, a search method more suitable for a mobile search scenario may be provided.

In order to achieve the above objectives, embodiments of a second aspect of the present disclosure provide a mobile search apparatus based on artificial intelligence. The mobile search apparatus includes: a receiving module, configured to receive a query; an acquiring module, configured to acquire search results corresponding to the query according to existing resources, in which the existing resources include resources provided to a search engine by a content provider, and the search results include requirement-satisfied results and results motivating a potential requirement; and a displaying module, configured to display the search results on a search result page, and when a user clicks a search result on the search result page, to display pages provided by the search engine and in correspondence with the search result clicked.

With the mobile search apparatus based on artificial intelligence according to embodiments of the second aspect of the present disclosure, by performing the above processing, a search method more suitable for a mobile search scenario may be provided.

Embodiments of the present disclosure also provide an electronic device, including: one or more processors; a memory; one or more programs stored in the memory, that when executed by the one or more processors, cause to perform the mobile search method according to any embodiment of the first aspect of the present disclosure.

Embodiments of the present disclosure also provide a non-transitory computer storage medium for storing one or more modules, when the one or more modules are executed, the mobile search method according to any embodiment of the first aspect of the present disclosure may be performed.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a flow chart of a mobile search method based on artificial intelligence according to an embodiment of the present disclosure;

FIG. 2 is a schematic diagram of requirement-satisfied results according to an embodiment of the present disclosure;

FIG. 3 is a schematic diagram of requirement-satisfied results according to another embodiment of the present disclosure;

FIG. 4 is a schematic diagram of results motivating a potential requirement according to an embodiment of the present disclosure;

FIG. 5 is a schematic diagram of results motivating a potential requirement according to another embodiment of the present disclosure;

FIG. 6a-6d are schematic diagrams of search result pages according to an embodiment of the present disclosure;

FIG. 7 is a schematic diagram of a scene page according to an embodiment of the present disclosure;

FIG. 8 is a schematic diagram of a content page according to an embodiment of the present disclosure;

FIG. 9 is a flow chart of a mobile search method based on artificial intelligence according to another embodiment of the present disclosure;

FIG. 10 is a system structure diagram corresponding to FIG. 9;

FIG. 11 is a block diagram of a mobile search apparatus based on artificial intelligence according to an embodiment of the present disclosure; and

FIG. 12 is a block diagram of a mobile search apparatus based on artificial intelligence according to another embodiment of the present disclosure.

### DETAILED DESCRIPTION

Reference will be made in detail to embodiments of the present disclosure, where the same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

For a better understanding of the present disclosure, the conventional search method is described firstly.

In the conventional search method, a search engine may grab webpage resources via a spider, and display webpage links as search results for the user after ordering the webpage resources according to information such as a query, such that a user may open a corresponding webpage by clicking a webpage link. In this case, user traffics may be distributed to the corresponding content providers directly, and the search engine may acquire commercial cashability by promoting and selling, such that the content providers may acquire commercial cashability by acquiring traffics from the search engine via contents created on their platform.

However, the above-mentioned conventional search method may have following problems.

A controlling ability of the conventional search engine on the resource ecology is insufficient. In the era of mobile internet, with the emergence of various blocked resources such as applications, official accounts and headline accounts, a large number of content providers introduce the traffics to their own blocked systems, which occupies a lot of time of the user. If the search engine still purely distributes the traffics, it will lead to a loss of users and a loss of an entrance domain of mobile internet.

The content provider may create a blocked content system gradually based on his or her own platform, causing that the conventional search engine is unable to acquire sufficient content, leading to a dissatisfaction of user's requirement and a loss of users.

In the mobile internet, the content providers have a poor commercial cashing pattern and commercial cashability based on themselves, and cannot acquire a precise and effective cashability as in a big data pattern.

The conventional search engine represents a deficiency in ordering and displaying, and may be unable to satisfy users' precise search requirements in a complex scenario. It may reduce an overall space utilization if duplicate contents occupy large space. In a case of dissatisfying users' precise search requirements and using additional space to motivate potential requirements, it is hard to seize users' using time in a mobile internet.

In conclusion, a conventional mobile search engine ecological chain has a serious insufficiency in controlling resource ecology, satisfying users' precise search requirements, assisting the resource providers to acquire cashability, realizing client access and cashability and the like. It is urgent to provide a new mobile search system and its ecological chain innovation.

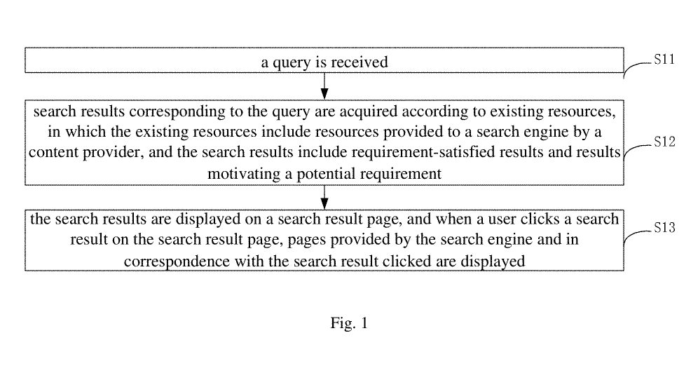

FIG. 1 is a flow chart of a mobile search method based on artificial intelligence according to an embodiment of the present disclosure.

Referring to FIG. 1, the mobile search method may include followings.

At block S11, a query is received.

For example, the query inputted in a form of a text, a speech or an image by the user may be received.

At block S21, search results corresponding to the query are acquired according to existing resources, in which the existing resources include resources provided to a search engine by a content provider, and the search results include requirement-satisfied results and results motivating a potential requirement.

In this embodiment, the content provider may provide self-created resources to the search engine actively. For example, a content filing platform may be set in the search engine, the content provider may file their original works to the system via the content filing platform. Alternatively, the content provider may file resources in his or her own website or application to the search engine via an open API (Application Programming Interface) of the content filing platform. By providing the content provider's own resources to the search engine, the closure of platform of the content provider may be broken, such that the search engine may acquire sufficient contents created by the content provider, which may better satisfy users' requirements. Further, the resources provided by the content provider to the search engine may be all resources created by the provider, such that the search engine may acquire more comprehensive contents.

After the search engine acquires the resources provided by the content provider, the resources may be processed, so as to acquire requirement-satisfied results and results motivating a potential requirement. Therefore, the users' requirements may be satisfied precisely and deeply.

Since the queries may be different, the requirement-satisfied results may include precisely-satisfied results and requirement-satisfied clusters.

When the query is a query with a single requirement, the requirement-satisfied results are the precisely-satisfied results.

When the query is a query with multiple requirements, the requirement-satisfied results are the requirement-satisfied clusters acquired by aggregating the search results corresponding to each requirement.

Further, when the search results are acquired according to the query, a requirement identification such as a personalization identification or a scene identification may be performed on the query, so as to satisfy the users' personalization requirements and scene requirements.

It should be understood that the search results acquired according to embodiments of the present disclosure may include search results acquired above, as well as search results acquired by grabbing webpage resources by a spider.

At block S13, the search results are displayed on a search result page, and when a user clicks a search result on the search result page, pages provided by the search engine and in correspondence with the search result clicked are displayed.

After the search engine requires the search results, the search results may be displayed on the search result page provided by the search engine.

In some embodiments, when the query input by the user is a query with multiple requirements, a requirement identification may be performed on the query. A semantic identification technology+clickquery+a scene of the user (who, when, where, type of the network, type of the phone, etc.) may be used to identify and classify the requirements of the query input by the user, so as to acquire a series of scene requirement classifications. After that, an aggregation may be performed on the search results according to requirements to acquire a series of single-requirement-satisfied clusters which are then ordered according to user's demand intensities for these requirements in the big data pattern, so as to acquire a series of requirement-satisfied clusters.

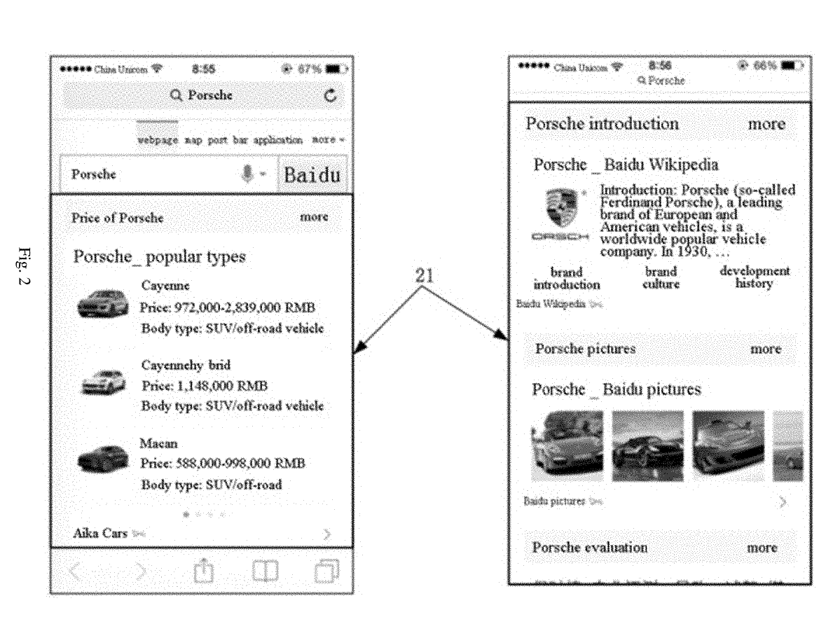

For example, if the query is “Porsche”, the user's main requirements including prices of Porsche, introductions of Porsche, pictures of Porsche and evaluations of Porsche may be acquired according to the requirement identification performed on the query. Therefore, four requirement-satisfied clusters can be acquired by performing the aggregation on original search results according to the requirement classifications and demand intensities. Referring to FIG. 2, the four requirement-satisfied clusters 21 are displayed on the search result page. It could be understood that, the search results are generally displayed on multiple screens (multiple pages) due to a limitation of a terminal size. The user may check the search results on different split-screens by sliding up or down. In this embodiment, displaying the search results on two split-screens is taken as an example.

In some embodiments, when the query input by the user is a query with a single requirement, a semantic identification technology+clickquery+a scene of the user (who, when, where, type of the network, type of the phone, etc.) may also be used firstly to identify and classify the requirement of the query input by the user, so as to acquire precise results satisfying the single requirement from the whole network.

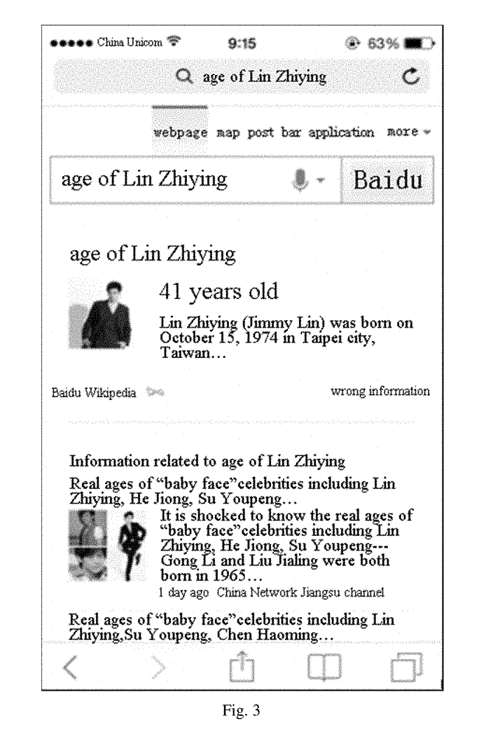

For example, if the query is “age of Lin Zhiying”, the user's main requirement including age of Lin Zhiying may be acquired, and the precisely-satisfied results which may include Lin Zhiying's age value and latest news related to Lin Zhiying's age are displayed, as shown in FIG. 3.

In addition, the search results according to this embodiment include the requirement-satisfied results as described above, as well as results motivating a potential requirement.

When acquiring the results motivating the potential requirement, user's requirement identification results, user's personalization information (a personal searching history, a portrait etc.) and user's scene information (who, when, where, type of the network, type of the phone, what query is used, etc.) may be used.

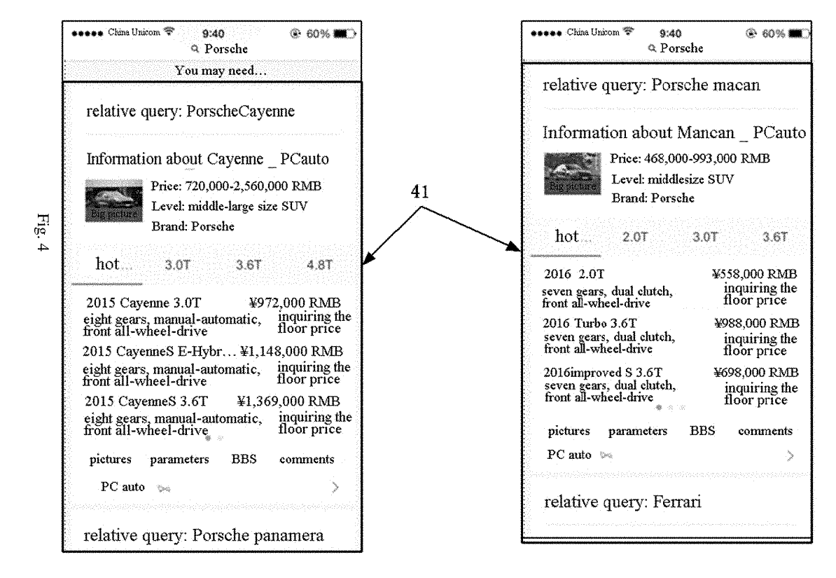

For example, if the query is “Porsche”, not only the requirement-satisfied results as shown in FIG. 2 but also the results 41 motivating the potential requirement (such as Porsche Cayenne, Porsche panamera, Porsche macan, Ferrari, etc.) as shown in FIG. 4 are displayed on the search result page. Thus, the search results displayed on the search result page include: the requirement-satisfied clusters+the results motivating the potential requirement.

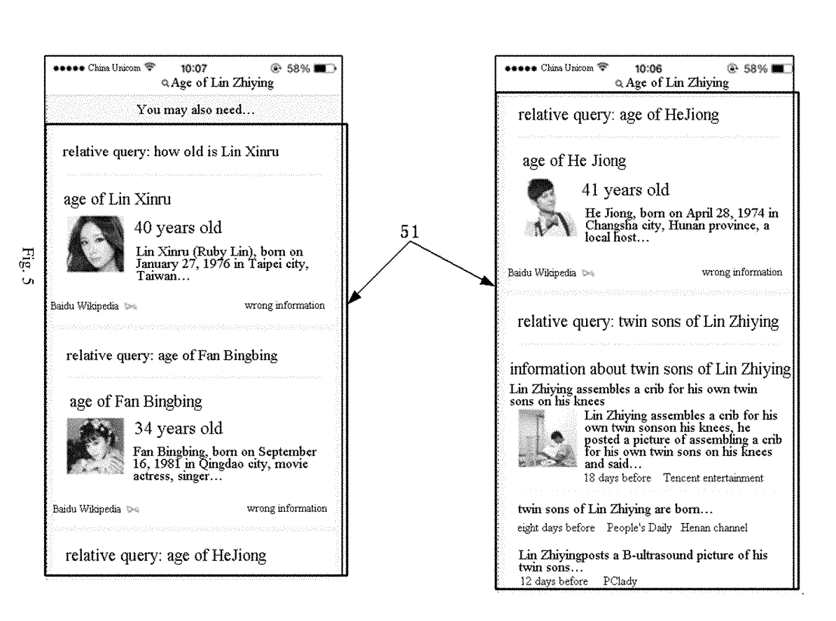

For example, if the query is “age of Lin Zhiying”, not only the requirement-satisfied results as shown in FIG. 3 but also the results 51 motivating the potential requirement (such as how old is Lin Xinru, age of Fan Bingbing, twin sons of Lin Zhiying, etc.) as shown in FIG. 5 are displayed on the search result page. Thus, the search results displayed on the search result page include: the precisely-satisfied results+the results motivating the potential requirement.

Further, when the user clicks a search result displayed on the search result page, the search engine may open a new page to display content corresponding to the search result clicked by the user.

In the conventional search method, the search results are webpage links. After the user clicks a search result, the webpage corresponding to the search result clicked is displayed, in which the webpage is a page provided by the content provider, rather than a self-contained page of the search engine, such that the user traffics can be distributed to the content provider. However, in this embodiment, after the user clicks a search result, the page displayed is still a page provided by the search engine, rather than a page provided by the content provider, such that the user traffics may be blocked in the search engine, thereby avoiding a loss of user traffics and ensuring that the search engine is regarded as an entrance domain of mobile internet.

In this embodiment, in accordance to different search results clicked by the user, pages provided by the search engine and in correspondence with the search result clicked may include a scene page or a content page.

Scene Page

Each result displayed on the search result page may refer to a “scene”, and each scene may correspond to a “scene page”. The content in the scene page may refine or expand a certain scene, including results in a same classification as a given result, results similar to or relative to the given result. A function of the scene page is to provide a deep reading and viewing scene to the user who is interested in a given scene.

Content Page

The content page includes detail content of each result in the search result page or the scene page, including but not limited to a detail report of a piece of news, a detail description of an object, detail content of a webpage and the like.

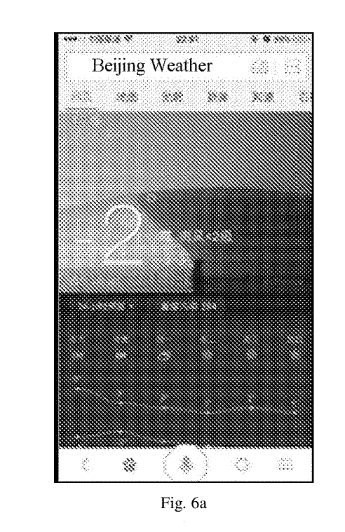

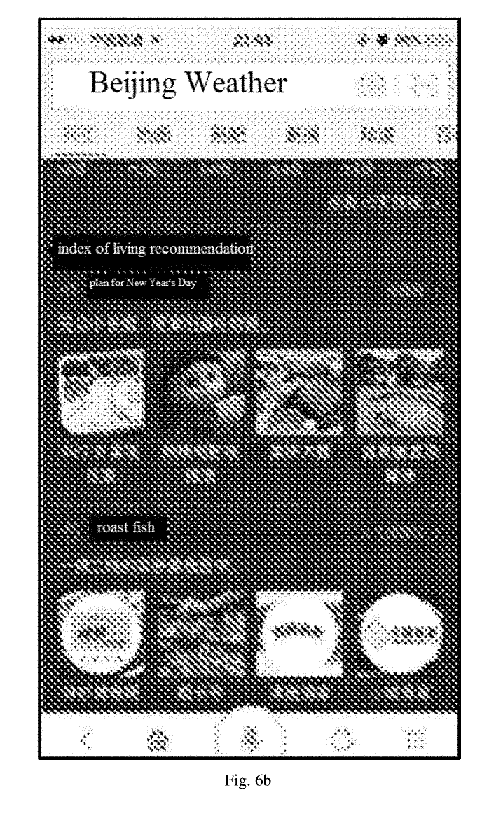

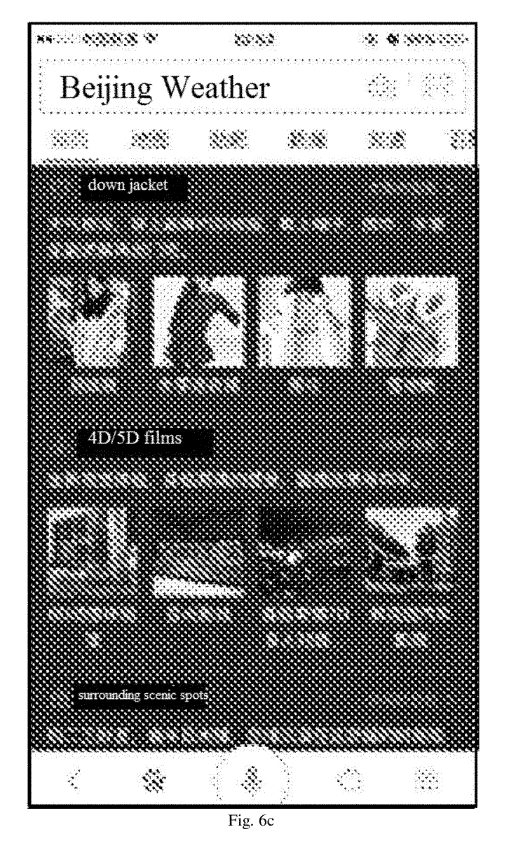

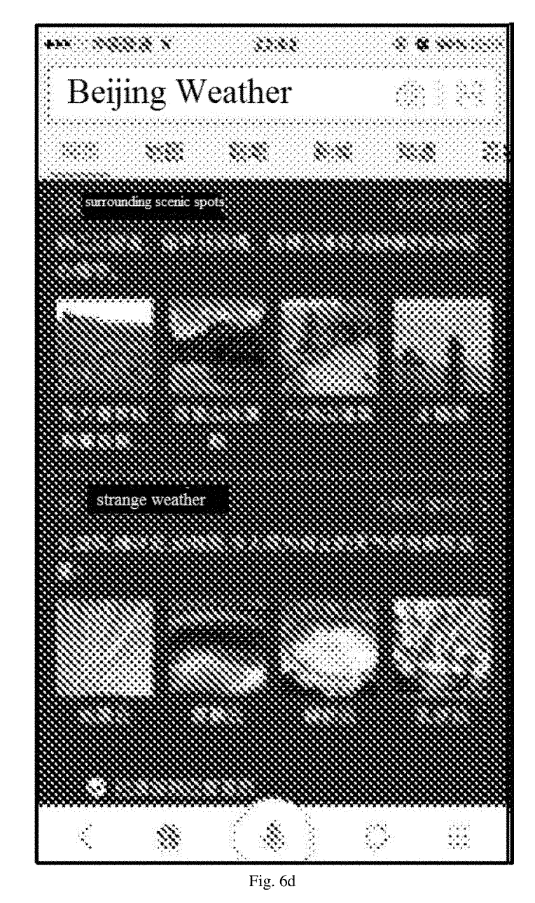

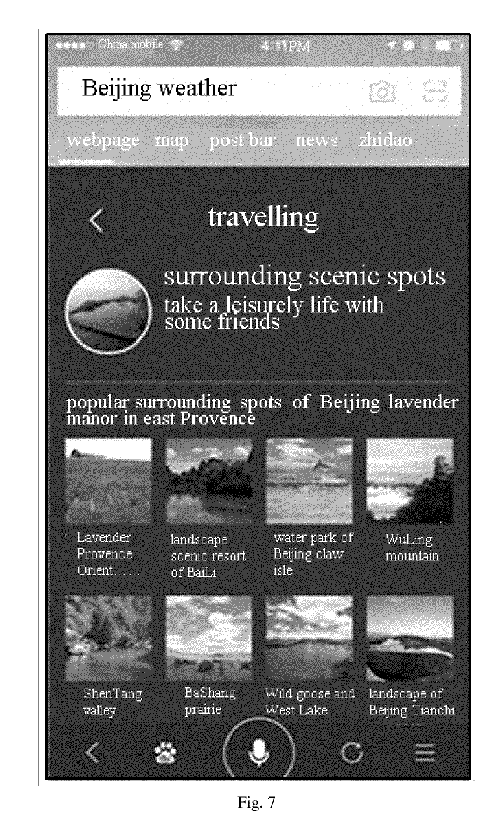

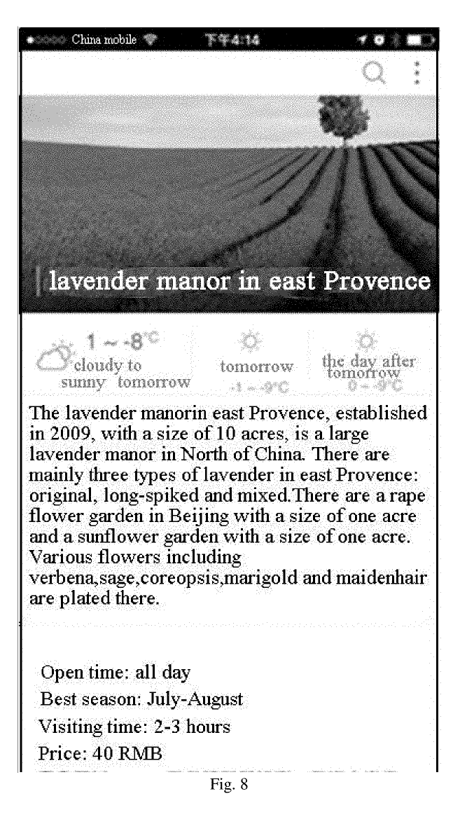

For example, if the query is “Beijing weather”, the search result page may be shown in FIGS. 6a-6d. The scene page corresponding to surrounding scenic spots is shown in FIG. 7. The content page corresponding to a result “a lavender manor in east Provence” is shown in FIG. 8.

By above processing, the search result page may be displayed in a manner of including the precisely-satisfied results or the requirement-satisfied clusters+potential-requirement-satisfied clusters. Further, the user may smoothly switch and continuously circulate among the search result page, the scene page and the content page in a way of that a content page provides precisely-satisfied results and a scene page provides a viewing motivation, such that user's searching experience can be improved and the user's using time can be lengthened. In addition, the user may subscribe and pay attention to the content of the scene page or the content page.

Further, the conventional search system may only realize promotion and cashability of the search result page. The present disclosure may realize the cashabilities of the search result page, the scene page and the content page, which expands the searching cashability from a horizontal dimension and a vertical dimension.

In this embodiment, by acquiring search results from resources provided by the content provider to the search engine, it may be avoided to distribute the user traffics to the content provider, such that the user traffics may be blocked inside of the search engine. By providing the requirement-satisfied results and the results motivating a potential requirement, the user requirements may be satisfied completely, such that a situation of “precisely satisfying the user's query requirement in time and precisely distributing traffics” may be developed to a situation of “deeply satisfying a search requirement and providing a one-stop solution with smoothly viewing experience” on a client. In addition, by acquiring the resources provided by the content provider, a situation of “conventionally grabbing without grasping contents” with respect to content production may be developed to a situation that “the search engine may create and grasp the content by providing a platform”

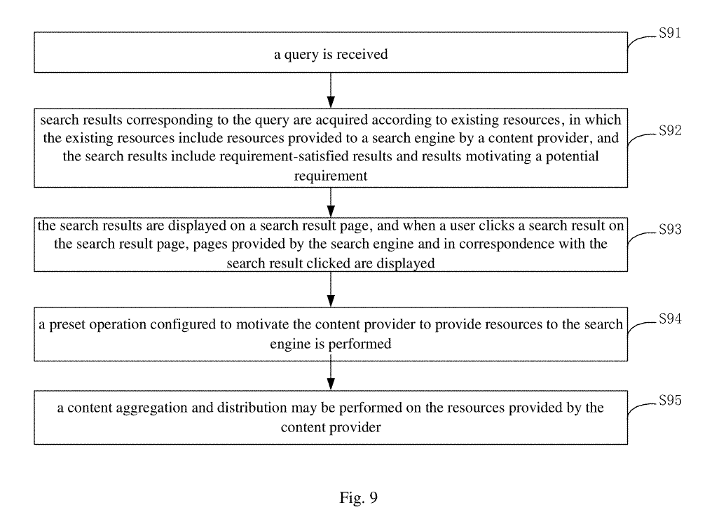

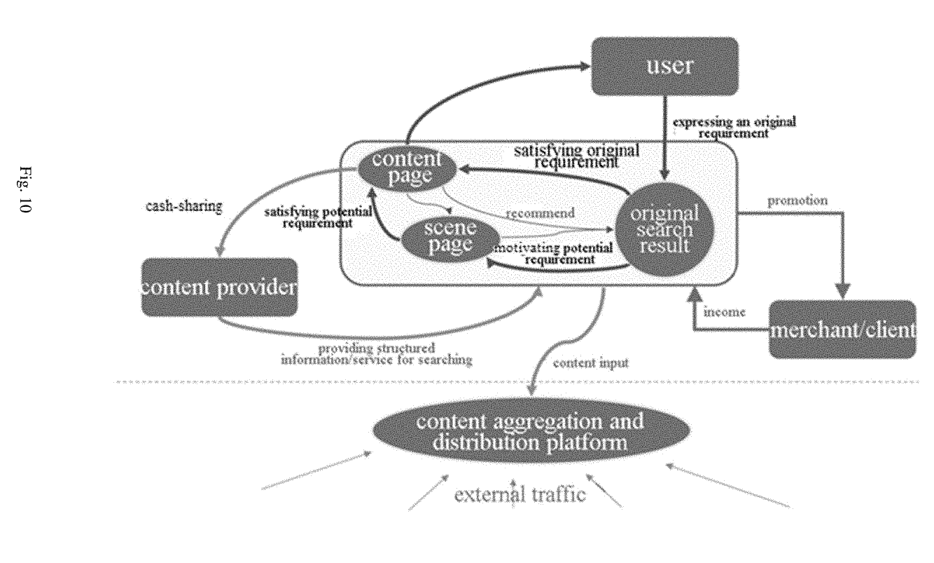

FIG. 9 is a flow chart of a mobile search method based on artificial intelligence according to another embodiment of the present disclosure. FIG. 10 is a system structure diagram corresponding to FIG. 9.

Referring to FIG. 9, the mobile search method may include followings.

At block S91, a query is received.

At block S92, search results corresponding to the query are acquired according to existing resources, in which the existing resources include resources provided to a search engine by a content provider, and the search results include requirement-satisfied results and results motivating a potential requirement.

At block S93, the search results are displayed on a search result page, and when a user clicks a search result on the search result page, pages provided by the search engine and in correspondence with the search result clicked are displayed.

Regarding detail descriptions of blocks S91-S93, reference may be made to the previous embodiment, which will not be described herein.

At block S94, a preset operation configured to motivate the content provider to provide resources to the search engine is performed.

The preset operation may be, for example, a cash-sharing application.

For example, a cash-sharing platform may be set in the search engine, an outward traffic redirecting manner used in the conventional search system may be developed to an outward cash-sharing manner. By providing the cash-sharing platform, the high-valued cashing of traffics of the search result page+the scene page+the content page may be realized by a merchant/client promotion and other cashing manners, such that a high percent of cash can be provided to an author/developer via the cash-sharing platform and the pure traffic redirecting can be converted to a direct cash-sharing, thus improving not only the cashability of the author/developer but also the ability of the search system in controlling the whole ecological chain.

Further, in some embodiments, the mobile search method may also include followings.

At block S95, a content aggregation and distribution may be performed on the resources provided by the content provider.

As shown in FIG. 10, compared to the conventional search method, a content aggregation and distribution platform is added. When the resources provided by the content provider to the search engine reaches a certain magnitude, the content aggregation and distribution platform is established. The resources provided by the content provider may be aggregated via the content aggregation and distribution platform so as to provide information outside. The user traffics of the content aggregation and distribution platform may come from the search engine (so-called inner traffics). For example, when the user searches for information via the search engine, the content aggregation and distribution platform may be recommended and displayed to the user. Alternatively, the user traffics of the content aggregation and distribution platform may be the traffics accessed by the user directly (so-called outer traffics). After the user knows a website of the content aggregation and distribution platform or downloads an application of the content aggregation and distribution platform, the content aggregation and distribution platform may be accessed directly.

In addition, when the content aggregation and distribution platform displays the search results to the user, the search result page, the scene page and the content page may also be used, so as to realize a smooth circulation with the search engine. Moreover, by an inward-and-outward traffic redirecting and a cashing of the search result page, the scene page and the content page, a cash-sharing of authors/developers may be performed via a cash-sharing system.

By the above processing described according to this embodiment, an orientation and an objective of the search engine may be changed essentially. On the client, the situation of “precisely satisfying the user's query requirement in time and precisely distributing traffics” may be developed to the situation of “deeply satisfying a search requirement and providing a one-stop solution with smoothly viewing experience”, while for the content production, the situation of “conventionally grabbing without grasping contents” may be developed to the situation that “the search engine may create and grasp the content by providing a platform”, and on the resource side, a situation of “distributing traffics” may be developed to a situation of “direct distributing and cashing effectively”. The specific advantages may be described as follows.

With respect to the ability of controlling resource ecology, on one hand, by creating content in the search engine via the content filing platform, a problem of loss and closure of content caused when the conventional content provider creates contents by himself/herself may be solved, such that the search engine may grab the content; on the other hand, the user may switch and circulate among the new mobile search system via the scene page, the content page and the content aggregation and distribution platform, thus avoiding a user loss due to the blocked resources.

With respect to a cashing of the content provider, on one hand, a cost of traffic management and cashing may be saved for the content provider; on the other hand, a better cashing pattern and cashability may be provided based on the big data obtained by the search system and the direct outward cashing may be realized, therefore providing a high-valued cashing to the content provider.

With respect to the merchant/client, based on the conventional promotion, the commercial cashability may be realized by the scene page and the content page deeply satisfying the user requirements.

With respect to deeply satisfying user's requirements and seizing user's using time, on one hand, a high-valued content can be acquired via the content filing platform, such that the user's precise requirement can be satisfied via the content page, the user's potential requirement can be motivated via the scene page, and the content aggregation and distribution platform can be formed to absorb outside traffic users when the contents are accumulated to some extent, thus a seamless circulate of the internal-and-external search users in the new mobile search system can be realized.

In conclusion, the new created mobile search system provided by the present disclosure may deeply motivate and satisfy the user's potential requirements based on a user searching experience improvement, such that the user may acquire a smooth circulate in the new mobile search system, thereby acquiring a long user time. At the same time, a stronger ability of controlling the whole resource ecology may be acquired and high-valued cashing may be provided to the resource provider, thus realizing a win-win relation among the whole ecology.

FIG. 11 is a block diagram of a mobile search apparatus based on artificial intelligence according to an embodiment of the present disclosure. Referring to FIG. 11, the mobile search apparatus 110 may include: a receiving module 111, an acquiring module 112 and a displaying module 113.

The receiving module 111 is configured to receive a query.

The acquiring module 112 is configured to acquire search results corresponding to the query according to existing resources, in which the existing resources include resources provided to a search engine by a content provider, and the search results include requirement-satisfied results and results motivating a potential requirement.

The displaying module 113 is configured to display the search results on a search result page, and when a user clicks a search result on the search result page, to display pages provided by the search engine and in correspondence with the search result clicked.

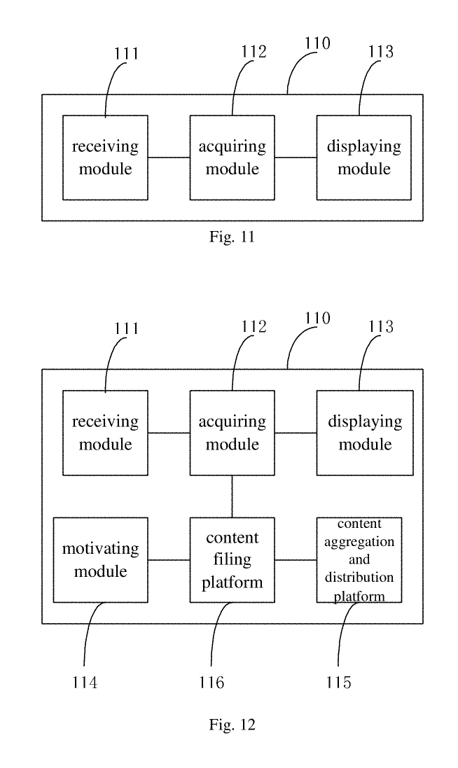

In some embodiments, referring to FIG. 12, the mobile search apparatus 110 also includes followings.

A motivating module 114 is configured to perform a preset operation configured to motivate the content provider to provide resources to the search engine.

In some embodiments, referring to FIG. 12, the mobile search apparatus 110 also includes followings.

A content aggregation and distribution platform 115 is configured to perform a content aggregation and distribution on the resources provided by the content provider.

In some embodiments, referring to FIG. 12, the mobile search apparatus 110 also includes followings.

A content filing platform 116 is configured to receive resources created by the content provider, or, to receive resources in a website or an application of the content provider filed by the content provider via an open API.

In some embodiments, the receiving module 111 is further configured to receive the query inputted in a form of a text, a speech or an image.

In some embodiments, the requirement-satisfied results include: precisely-satisfied results or requirement-satisfied clusters, in which the precisely-satisfied results are the search results corresponding to a query with a single requirement, and the requirement-satisfied clusters are search results corresponding to a query with a plurality of requirements.

In some embodiments, the pages provided by the search engine and in correspondence with the search result clicked include: a scene page or a content page, in which, when the user clicks a search result, a scene page or a content page corresponding to the search result clicked is displayed, or, when the user clicks a result on the scene page, the content page corresponding to the result clicked is displayed.

As the above-mentioned mobile search apparatus corresponds to the mobile search method, regarding the specific description of the modules in the mobile search apparatus, reference may be made to the descriptions in the method embodiments, which will not be described in detail herein.

By the above processing described in this embodiment, a search method more suitable for a mobile search scenario may be provided.

Embodiments of the present disclosure also provide an electronic device, including: one or more processors; a memory; one or more programs stored in the memory, that when executed by the one or more processors, cause to perform following acts.

At block S1, a query is received.

At block S2, search results corresponding to the query are acquired according to existing resources, in which the existing resources include resources provided to a search engine by a content provider, and the search results include requirement-satisfied results and results motivating a potential requirement.

At block S3, the search results are displayed on a search result page, and when a user clicks a search result on the search result page, pages provided by the search engine and in correspondence with the search result clicked are displayed.

Embodiments of the present disclosure also provide a non-transitory computer storage medium storing one or more modules, when the one or more modules are executed, following acts are performed.

At block S1, a query is received.

At block S2, search results corresponding to the query are acquired according to existing resources, in which the existing resources include resources provided to a search engine by a content provider, and the search results include requirement-satisfied results and results motivating a potential requirement.

At block S3, the search results are displayed on a search result page, and when a user clicks a search result on the search result page, pages provided by the search engine and in correspondence with the search result clicked are displayed.

It should be noted that terms such as “first” and “second” are used herein for purposes of description and are not intended to indicate or imply relative importance or significance. Thus, the feature defined with “first” and “second” may comprise one or more this feature. In the description of the present disclosure, “a plurality of” means two or more than two, unless specified otherwise.

It will be understood that, the flow chart or any process or method described herein in other manners may represent a module, segment, or portion of code that comprises one or more executable instructions to implement the specified logic function(s) or that comprises one or more executable instructions of the steps of the progress. And the scope of a preferred embodiment of the present disclosure includes other implementations in which the order of execution may differ from that which is depicted in the flow chart, which should be understood by those skilled in the art.

It should be understood that the various parts of the present disclosure may be realized by hardware, software, firmware or combinations thereof. In the above embodiments, a plurality of steps or methods may be stored in a memory and achieved by software or firmware executed by a suitable instruction executing system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable memory medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable memory medium.

The above-mentioned memory medium may be a read-only memory, a magnetic disc, an optical disc, etc.

Reference throughout this specification to “one embodiment”, “some embodiments,” “an embodiment”, “a specific example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated that the above embodiments are explanatory and cannot be construed to limit the present disclosure, and changes, alternatives, and modifications can be made in the embodiments without departing from scope of the present disclosure by those skilled in the art.

1. A mobile search method based on artificial intelligence, comprising:
S1, receiving a query;
S2, acquiring search results corresponding to the query according to existing resources, wherein the existing resources comprise resources provided to a search engine by a content provider, and the search results comprise requirement-satisfied results and results motivating a potential requirement; and
S3, displaying the search results on a search result page, and when a user clicks a search result on the search result page, displaying pages provided by the search engine and in correspondence with the search result clicked.

2. The mobile search method according to claim 1, further comprising:
S4, performing a preset operation configured to motivate the content provider to provide resources to the search engine.

3. The mobile search method according to claim 1, further comprising:
S5, performing a content aggregation and distribution on the resources provided by the content provider.

4. The mobile search method according to claim 1, further comprising:
S6, receiving resources created by the content provider via a content filing platform or resources in a website or an application of the content provider filed by the content provider via an open API of the content filing platform.

5. The mobile search method according to claim 1, wherein the requirement-satisfied results comprise: at least one kind of precisely-satisfied results and requirement-satisfied clusters, wherein the precisely-satisfied results are search results corresponding to a query with a single requirement, and the requirement-satisfied clusters are search results corresponding to a query with a plurality of requirements.

6. The mobile search method according to claim 1, wherein the pages provided by the search engine and in correspondence with the search result clicked comprise: a scene page or a content page, in which, when the user clicks a search result, a scene page or a content page corresponding to the search result clicked is displayed, or, when the user clicks a result on the scene page, a content page corresponding to the result clicked is displayed.

7. The mobile search method according to claim 1, wherein receiving a query comprises:
S11, receiving the query inputted in a form of a text, a speech or an image.

8.-12. (canceled)

13. An electronic device, comprising:
one or more processors;
a memory;
one or more programs stored in the memory, that when executed by the one or more processors, cause to perform the mobile search method including:
S1, receiving a query;
S2, acquiring search results corresponding to the query according to existing resources, wherein the existing resources comprise resources provided to a search engine by a content provider, and the search results comprise requirement-satisfied results and results motivating a potential requirement; and
S3, displaying the search results on a search result page, and when a user clicks a search result on the search result page, displaying pages provided by the search engine and in correspondence with the search result clicked.

14. A non-transitory computer storage medium storing one or more modules, wherein when the one or more modules are executed, the mobile search method is performed including:
S1, receiving a query;
S2, acquiring search results corresponding to the query according to existing resources, wherein the existing resources comprise resources provided to a search engine by a content provider, and the search results comprise requirement-satisfied results and results motivating a potential requirement; and
S3, displaying the search results on a search result page, and when a user clicks a search result on the search result page, displaying pages provided by the search engine and in correspondence with the search result clicked.

15. The mobile search method according to claim 5, wherein when the requirement-satisfied results comprise the requirement-satisfied clusters, acquiring search results corresponding to the query comprises:
aggregating search results corresponding to each of the plurality of requirements to acquire the requirement-satisfied clusters.

16. The mobile search method according to claim 1, further comprising:
performing a requirement identification and classification on the query.

17. The mobile search method according to claim 16, further comprising:
sequencing the search results according to requirement classifications and demand identifies for each requirement classification.

18. The electronic device according to claim 13, wherein the mobile search method further comprises:
S4, performing a preset operation configured to motivate the content provider to provide resources to the search engine.

19. The electronic device according to claim 13, wherein the mobile search method further comprises:
S5, performing a content aggregation and distribution on the resources provided by the content provider.

20. The electronic device according to claim 13, wherein the mobile search method further comprises:
S6, receiving resources created by the content provider via a content filing platform or resources in a website or an application of the content provider filed by the content provider via an open API of the content filing platform.

21. The electronic device according to claim 13, wherein the requirement-satisfied results comprise: at least one kind of precisely-satisfied results and requirement-satisfied clusters, wherein the precisely-satisfied results are search results corresponding to a query with a single requirement, and the requirement-satisfied clusters are search results corresponding to a query with a plurality of requirements.

22. The electronic device according to claim 13, wherein the pages provided by the search engine and in correspondence with the search result clicked comprise: a scene page or a content page, in which, when the user clicks a search result, a scene page or a content page corresponding to the search result clicked is displayed, or, when the user clicks a result on the scene page, a content page corresponding to the result clicked is displayed.

23. The electronic device according to claim 13, wherein receiving a query comprises:
S11, receiving the query inputted in a form of a text, a speech or an image.

24. The electronic device according to claim 13, wherein the mobile search method further comprises:
performing a requirement identification and classification on the query.

25. The electronic device according to claim 24, wherein the mobile search method further comprises:
sequencing the search results according to requirement classifications and demand identifies for each requirement classification.
